(19) United States
(12) Patent Application Publication
(10) Pub. No.: US 2005/0050060 A1
(43) Pub. Date: Mar. 3, 2005

(54) Data structure for range-specified algorithms

(76) Inventors: Gerard Damm, Ottawa (CA); Bashar Bou-Diab, Ottawa (CA); Yuke Wang, Plano, TX (US); Yun Zhang, Richardson, TX (US); Yiyan Tang, Richardson, TX (US); Anand Krishnamurthy, Richardson, TX (US); Lie Qian, Richardson, TX (US)

Correspondence Address: Law Office of Jim Zegeer, Suite 108, 801 North Pitt Street, Alexandria, VA, 22314, US

(21) Appl. No.: 10/648,791

(22) Filed: Aug. 27, 2003

(51) Int. Cl. G06F 7/00

(52) U.S. Cl. 707/100

(57) ABSTRACT

A disjoint graph structure for packet classification in communication systems is presented. The disjoint graph is comprised of two types of data structures; an elementary interval tree (EIT) and a disjoint interval tree (DIT). The disjoint graph is constructed based on a range-specified rule set finding particular application in the classification of data packets. Each rule in the rule set has an equal number of fields and each field specifies a range referred to as an integer interval having a lower and an upper bound. The disjoint graph has the same number of layers as there are fields in each rule. The layers are comprised of nodes, and each node has an associated rule set selected from the range-specified rule set. The disjoint graph enables packet classification in only one pass through the tree. The EIT and DIT structures are also presented in detail.

### FIELD OF THE INVENTION

This invention relates to computer-based communications systems and more particularly to data structures that represent sets of intervals for use in range-specified calculations for such systems.

### BACKGROUND OF THE INVENTION

In the general field of computer-based systems, involving multiple and varied work stations located at multiple and diverse sites providing services of differing classification the procedures for controlling data flow are known to be extremely complex.

Typically, data flow is governed by sets of rules which dictate, amongst other things, quality of service, security and metering. The data usually is in the form of packets with a header having particular information such as source, destination and service related criteria. The manner in which the data is handled in the system involves examining the header in relation to these sets of rules. In such an environment, range specified rules become the most viable option to provide an acceptable level of control. This is largely due to the fact that it would be practically impossible to compare all of the data with the sets of rules in a high speed system. Range-specified rules, according to the following description, can be broadly described as a set of rules defined using intervals (or ranges) for each field. The fields can be defined arbitrarily, depending on the applications. A typical example for the fields is the 5-tuple (IP source address, IP destination address, TCP protocol, source port, destination port), but any arrangement of any number of fields is possible, as long as the corresponding data exists in the packets (header and payload) which are going to be matched. The ranges can be thought of as integer intervals, but the invention applies to any set of ordered values on which the concept of interval can be defined. A packet matches a rule if each of its fields (as extracted, or parsed, from the packet) is contained within the corresponding ranges of the rule. If the rule set is ordered top-down, then the best matching rule for a packet is the matching rule closest to the top.

An example of the environment contemplated by the present invention is in an IP router which processes a large number of packets coming from and destined for a large number of user sites. To provide service to end users that is better than “best effort” the system needs to strictly adhere to sets of rules which dictate how data packets are processed. Obviously, taking into consideration the vast volume of traffic in communications systems such as the Internet, it would be difficult to compare each packet with a rule and to determine whether it meets established criteria. Thus the aforementioned range based algorithm can be applied.

For the sake of the following description reference is made to methods of implementing algorithms for multi-field packet classification by range specified rules used in IP routers. Classification is a very important function that is a part of applications such as firewall, IPsec and Quality of service. Firewall needs to classify packets based on pre-defined set of rules so that it can filter/block some flow packets from entering the network. IPsec needs to classify packets based on rules so that specific flow packets can be matched to the corresponding security policy and associations that indicate the security algorithms, and secure keys can be applied to the flow packets. Quality of service needs to perform classification function on packets, so that Quality of service attributes like delay bounds, packet loss bounds and bandwidth can be associated with the flow packets. In VPN environments, all the three applications of firewall, IPsec, and Quality of service may have to be applied to the edge router device. Hence, efficient implementation of the classification function becomes even more vital in such environments. Improved classification algorithms can guarantee high-performance with reduced resource requirements for implementation. The capacity of the existing application of the packet classification algorithms can be gracefully enlarged in terms of the computational resources. It will be apparent to one skilled in the art, however, that the algorithms can also apply to other calculations where a range-based or specified subset of rules is used.

As used in this application packet classification is the process of categorizing packets into “flows” in an Internet router based on one or more fields in the packet header. All packets belonging to the same flow obey a predefined rule and are processed in a similar manner by the router. This classification process is used in ACLs (Access Control Lists) for security, QoS, or for Metering for instance.

An algorithm for Multi-field packet classification by range specification takes a rule set and a packet as inputs, finds the best matching rule for the packet in the rule set based on the values of multiple fields in the packet header. A rule set consists of a finite number of rules. Each rule in the rule set contains multiple fields specified by ranges, where a range is an integer interval with a lower bound and an upper bound. Each rule also has a rule number.

A single field of a given rule set is a set of integer intervals. Given a set of integer intervals, a set of elementary intervals and a set of disjoint intervals can be obtained. The elementary intervals break down the set of integer intervals into smaller but necessary elements that are non-overlapping, while the disjoint intervals combine the overlapping integer intervals in the set of integer intervals together to form larger integer intervals that are disjoint to each other.

A matching rule for a given packet satisfies the principle that the value of each field of the packet falls into the value range of the corresponding field of the rule. The best matching rule is the matching rule with the smallest rule number among all the matching rules in the rule set, given the convention that rules are numbered from the highest priority to the lowest priority.

The elementary interval, in addition to its application for packet classification as described above also supports stabbing query. Stabbing query is the type of query where a point data is queried against a set of intervals to determine which of those intervals contains the point. Stabbing query may be used for certain applications, such as IP routing. Data structures for stabbing queries can also be extended to multi-dimension to serve for packet classification in IP routers. As previously described, a packet classification algorithm performs multi-dimensional point query against a set of rules, where the point is multi-dimensional and each rule consists of multiple intervals (ranges).

Given a set of intervals and a point of the stabbing query, the Elementary Interval Tree is used to represent the set of intervals according to one aspect of the invention. Also discussed herein is the Elementary Interval Tree Construction algorithm used to construct the data structure, and the Elementary Interval Tree Query algorithm to perform stabbing query on the data structure.

According to this aspect, given an interval [1, u] with two endpoints: the lower endpoint 1 and the upper endpoint u, the interval contains a point p if 1≦p≦u. A set of intervals contains a finite number of intervals, where each interval has an identifier. Given a set of intervals, by projecting the endpoints of each interval to a line, the endpoints divide the line into small partitions, called elementary intervals. The elementary intervals break down the set of intervals into smaller but necessary elements that are non-overlapping. The elementary interval tree proposed in the invention is an augmented binary search tree that stores each of the elementary intervals in one node to represent a set of intervals.

Also contemplated by the present invention is the design of a data structure that represents a set of intervals to find maximum disjoint intervals for the set of intervals. Again, this data structure finds application for packet classification in IP routers.

In this aspect an interval [1, u] has two endpoints: lower endpoint l and upper endpoint u. Two intervals [l₁, u₁] and [l₂, u₂] overlap if [l₁, u₁]∩[l₂, u₂]≠Ø. A set of intervals contains a finite number of intervals, where each interval also has an identifier. Given a set of intervals, I={I₁,I₂, . . . Iₙ}, the set of disjoint intervals of I is defined as {Î₁, Î₂, . . . ,Î_{L}},
1. I₁∪I₂∪ . . . ∪Iₙ=Î₁∪Î₂∪ . . . ∪Î_{L};
2. ∀Îₐ, Î_{b}, a≠b, Îₐ∪Î_{b}=Ø;
3. ∀Îₗ, Î₁=I₁′∪ . . . , ∪I_{K}′, Iₖ′∈{I₁, I₂, . . . , Iₙ}, 1≦k≦K;
4. ∀Iᵢ, ∃Îₐ, Iᵢ⊂Îₐ, ∀Î_{b},Î_{b}≠Îₐ, IᵢÎ_{b}.

The disjoint intervals combine the overlapping intervals in the set of intervals together to form larger intervals that are disjoint to each other.

This data structure could be used to facilitate intersection query as well as stabbing query. Given a set of intervals, the intersection query is to determine which of those intervals overlap a given interval, while the stabbing query is to determine which of those intervals overlap a given point.

Intersection query and stabbing query are important for certain applications, such as IP routing. The data structure proposed here could also be used to facilitate multi-dimensional domains problem, such as packet classification used in IP routers. Packet classification algorithm performs point query against a set of rules, where the point is multi-dimensional and each rule consists of multiple intervals (ranges). Intersection query and stabbing query are also useful for computer graphics, large knowledge-based systems, and some computational geometric problems.

In this aspect, given a set of intervals, the Disjoint Interval Tree represents the set of intervals to facilitate intersection query, stabbing query and packet classification. Also, the Disjoint Interval Tree Construction algorithm is used to construct a disjoint interval tree, and the Disjoint Interval Tree Point Query algorithm is used to perform stabbing query, and the Disjoint Interval Tree Interval Query algorithm is used to perform intersection query.

Prior solutions for indexing intervals to support intersection query and stabbing query include segment tree, interval tree, priority search tree, interval binary search tree, point-range tree, etc. However, no solution has ever been proposed to find disjoint intervals for a given set of intervals.

### PRIOR ART

The prior art solutions respecting the disjoint graph aspect include FIS (Fat Inverted Segment) tree based classification algorithm, Ternary Content Addressable Memory (TCAM) implementation, and classical prefix-based classification algorithms.

The FIS trees based classification algorithm for range-specified rules is one of the prior art solution. The FIS trees for multiple fields of a given rule set is recursively constructed based on the FIS tree for a single field of a give rule set.

The FIS tree is a tree-like data structure to represent a set of integer intervals. The leaf nodes of the FIS tree store the elementary intervals of the set of integer intervals, and all the other nodes beside leaf nodes store the integer interval with the smallest lower bound and the maximum upper bound of all the integer intervals stored in their children. As opposed to the binary tree, the edges in the FIS tree point from child nodes to parent nodes.

Given a rule set based on D fields, the overall FIS trees is a tree containing D layers of Fⱼ-FIS trees with one F₁-FIS tree in the first layer and a set of Fⱼ-FIS trees in the j-th layer, where Fⱼ-FIS tree is a modified FIS tree to represent the set of integer intervals belonging to j-th field of a rule set that each node in the Fⱼ-FIS tree has an associated rule set. The overall D-layers FIS trees is recursively built by constructing D layer FIS trees. The associated rule set of a node contains rules whose j-th field contains the integer interval stored in the node but does not contain the integer interval stored in the parent node. Except for the first layer, the Fⱼ-FIS trees represents the integer intervals in the j-th field of the associated rule sets of the nodes in the Fⱼ₋₁-FIS trees. To find the best matching rule for a packet in the overall FIS trees, multiple traversals toward all the possible nodes are required.

Another prior art solution is that of TCAM (Ternary Content-Addressable Memory). TCAM is a specialized hardware that allows parallel pattern matching. TCAM memory arrays store the rules in decreasing order of priorities and compare the input key (packet field) against every element in the array in parallel. The highest priority rule that is matched to the key is returned. TCAMs are faster than software algorithms, but due to the parallel hardware, the magnitude of TCAM power consumption is multiple times higher than that of comparable SRAM based software solution. In comparison the graph based classification approaches are software solutions and rely on graph traversals to find the match to the input key. However, some methods explore the middle ground e.g. work done involves having smaller sized hardware (than TCAM) to do the parallel rule evaluation. These methods employ heuristic algorithms that divide the rule-sets across these hardware units.

Using classical prefix-based classification algorithms is another prior art solution. Through expansion of ranges to replace them with prefixes, classical prefix-based solutions, such as hierarchical-tries based classification algorithm, set-pruning tries based classification algorithm, could also be used to solve the range-based classification problem.

Given a rule set and a packet as inputs, the FIS trees based classification algorithm transforms the rule set into an overall FIS tree and finds the best matching rule for the packet on the overall FIS trees (FIG. 2). The problem in FIS trees based classification algorithm is that multiple traversals are required on the overall FIS trees toward all potential nodes containing the best matching rule during search. Multiple traversals are required because, except for the leaf nodes, a node in the overall FIS trees contains the integer intervals of all its children, thus, when a packet falls into the integer interval stored in one node, the search has to be performed on its parents, its parents' parents, and so on. A node can have only one parent in its Fⱼ-FIS, but it can have another parent in the next layer Fⱼ-FIS (i.e. Fⱼ₊₁-FIS). Multiple parents cause multiple paths to be explored.

To overcome this disadvantage, the Disjoint Graph based Classification Algorithm for range-specified rules according to the present invention, is implemented to allow that only a single path be traversed when performing classification for a packet. The disjoint graph based classification algorithm not only reduces the searching time required by the FIS trees based algorithm, but also requires less memory storage and data structure setup time than the FIS trees based algorithm.

The closest prior art with respect to the aforementioned elementary interval tree is the Point-Range tree.

The Point-Range Tree (PR-Tree) is an augmented Binary Search Tree to represent a set of intervals. The PR-Tree (FIG. 6) contains two types of nodes: Point nodes and Range nodes. All Point nodes are internal nodes and each Point node has Value, Left, Right, Equal and Ownedby fields. Value is one endpoint of an interval, Left (Right) is a pointer to the left (right) subtree holding values less than (greater than) Value, Equal contains a list of identifiers of intervals that contain Value, and Owned by contains a list of identifiers of intervals that have Value as an endpoint. All Range nodes are leaf nodes and each Range node has Value1, Value2, and Equal fields. Value1 and Value2 are both an endpoint of an interval, and Equal contains a list of identifiers of intervals that contain the open interval (Value1, Value2).

The PR-Tree allows dynamic insertions and deletions, and could maintain itself balanced by any balanced Binary Tree scheme. A balanced PR-Tree takes ο(log n) time for search. Insertion, deletion, and storage space have worst case requirements of ο(n log n+m), ο(n log² n+m), and ο(n log n), respectively, where n is the total number of intervals in the tree, and m is the number of nodes visited during insertion and deletion.

Multiway range search is another solution that uses B-tree to represent a set of intervals, where each node in the B-tree other than the root has k keys and k+1 subtrees and the endpoints of the set of intervals are stored as keys in the nodes of the B-tree. The B-tree data structure requires a linear search within each node to find the corresponding subtree.

Prior to PR-Tree, data structures such as Segment Tree, Interval Binary Search Tree, were also proposed to support stabbing query.

Given a set of intervals and a point, the PR-Tree based algorithm transforms the set of intervals to a PR-Tree and finds all intervals that contain the point on the PR-Tree. The problem in PR-Tree is that PR-Tree stores duplicated information that each elementary interval is stored twice: each of the endpoints is stored in a Point node and each elementary interval is stored as an open interval in a Range node. Both Point node and Range node have a list of identifiers of intervals associated with the nodes.

Multiway range search uses B-tree to represent a set of intervals. The B-tree data structure requires a linear search within each node to find the corresponding subtree.

The Elementary Interval Tree of the present invention reduces the memory storage required by PR-Tree by storing each elementary interval only once, which also reduces the insertion and deletion time correspondingly compared to Multiway range search.

The closest prior solution for intersection query is the Interval Tree. An interval tree is an augmented red-black tree that stores each of the intervals in one node to represent a set of intervals. Each node also stores the maximum value of any interval endpoint stored in the subtree rooted at the node.

The Interval Tree allows dynamic insertion and deletion. Both insertion and deletion can be performed in ο(log n) time on an interval tree of n nodes. The storage space is ο(n) since the interval tree stores each interval exactly once in the tree. The search time is ο(log n) to find one of the intervals that overlap a given interval. But multiple traversals are required to find all intervals that overlap a given interval.

The closest prior art solution for multi-dimensional domain problem is the method proposed in “Method and system for performing interval-based testing of filter rules” issued in Mar. 25, 2003, U.S. Pat. No. 6,539,394. The method disclosed transforms a set of intervals to a set of prefixes, and then constructs a decision tree based on the set of prefixes.

According to the U.S. Pat. No. 6,539,394 patent, given a set of intervals and an interval of intersection query, the Interval Tree based algorithm transforms the set of intervals to an Interval Tree and finds one of intervals that overlap the given interval. The problem with the Interval Tree solution is that multiple traversals are required by the Interval Tree to find all intervals that overlap the given interval. The Interval Tree can not be extended to multi-dimensional domains to support packet classification.

Given a set of intervals and a point, the PR-Tree based algorithm transforms the set of intervals to a PR-Tree and finds all intervals that contains the given point. The problem in PR-Tree is that PR-Tree stores duplicated information that each open interval stored in the Range node has each of its endpoints being stored in a Point node. The PR-Tree could be extended to support multiple dimensional problems, but need to consume too much memory storage.

The method proposed in U.S. Pat. No. 6,539,394 is a static algorithm that needs to reconstruct the decision tree when inserts or deletes of an interval are made to the interval set. Also, it needs large preprocessing time to construct the decision tree.

The Disjoint Interval Tree of the present invention can be used to construct a data structure that requires only a single path traversal to find all intervals that overlap a given interval and requires only half of the storage space compared to PR-Tree.

### SUMMARY OF THE INVENTION

According to one aspect of the invention a new tree-like structure is created. The tree-like structure, known as a disjoint graph, enables packet classification in only one pass of the tree.

The disjoint graph is comprised of two new types of data structures: an elementary interval tree (EIT) and a disjoint interval (DIT). The disjoint graph is constructed based on a range-specified rule set for classifying packets. Each rule in the rule set has an equal number of fields, D, and each field specifies a range, referred to as an integer interval, having a lower and an upper bound. The disjoint graph has the same number of layers, D, as there are fields in each rule. The layers are comprised of nodes, and each node has an associated rule set selected from the original (range-specified) rule set.

The first layer of the disjoint graph is an EIT. The remaining layers comprise a set of DITs and a set of EITs. The set of DITs at a given layer are constructed for the integer intervals stored in each node of the EITs in the preceding layer. The set of EITs at a given layer are constructed for the integer intervals stored in each node of the DITs of that layer. The associated rule set of a node of an EIT in a j-th layer contains rules whose j-th field contains the elementary interval stored in the node. The associated rule set of a node of a DIT in a j-th layer contains rules whose j-th field is contained by the disjoint interval stored in the node.

Elementary intervals are non-overlapping integer intervals. Disjoint intervals are intervals formed from overlapping integer intervals by combining them to form integer intervals that are disjoint from each other.

In accordance with a first aspect of the present invention there is provided a method of creating a tree-like data structure for use in carrying out range specified rule evaluations, the data structure having a rule specified rule set where each rule in the rule set has an equal number of fields and each field specifies a range having an upper and lower bound, there being the same number of layers in the structure as there are fields in each rule set, the method comprising: creating a first layer of the structure made up of a set of non-overlapping ranges; and creating one or more additional layers each made up of sets of non-overlapping ranges and sets of overlapping ranges; wherein range specified rule evaluations are carried out by one pass through the data structure.

In accordance with a second aspect of the present invention there is provided a method of creating an augmented binary tree structure from a range specified rule set, each rule in the rule set having an equal number of fields and each field specifying a range having an upper and lower bound forming a set of intervals, the method comprising: projecting end points of each interval of the set of intervals onto a line, the end points dividing the line into non-overlapping elementary intervals; and forming the tree structure such that each node of the tree contains a single elementary interval, an indication of original intervals associated with the elementary interval, and pointers to any adjacent nodes in the tree.

In accordance with a further aspect of the present invention there is provided a method of creating a disjoint interval tree from a range specified rule set each rule in the rule set having an equal number of fields and each field specifying a range having an upper and lower bound forming a set of intervals, the method comprising: combining overlapping intervals of the set of intervals to form larger intervals that are disjoint to each other; and evaluating the overlapping intervals to find the maximum disjoint intervals for the set of intervals.

Prior solutions for indexing intervals to support intersection query and stabbing query include segment tree, interval tree, priority search tree, interval binary search tree, point-range tree, etc. However, no solution has ever been proposed to find disjoint intervals for a given set of intervals.

### BRIEF DESCRIPTION OF THE DRAWINGS

The invention will now be described in greater detail with reference to the attached drawings wherein:

FIG. 1 illustrates a basic rule set with five rules, each rule having three fields;

FIG. 2 shows a FIS tree built for the rule set of FIG. 1;

FIG. 3 illustrates the construction of DITs and EITs;

FIG. 4 shows a disjoint graph constructed for the rule set of FIG. 1;

FIG. 5 shows an interval set S with three intervals;

FIG. 6 illustrates a PR-Tree built for the set of FIG. 5;

FIG. 7 illustrates the EIT built for the set of FIG. 5;

FIG. 8 illustrates an interval set S with five intervals;

FIG. 9 shows an interval Tree built for the set of FIG. 8;

FIG. 10 is a PR-Tree built for the set of FIG. 8;

FIG. 11 is a decision tree built for the set of FIG. 8;

FIG. 12a is a DIT for the set of FIG. 8; and

FIG. 12b is an EIT for the set of FIG. 8.

### DETAILED DESCRIPTION OF THE INVENTION

In accordance with the present invention, given a rule set and a packet, a Disjoint Graph based Classification Algorithm is presented. The algorithm includes the Disjoint Graph to represent the rule set to support packet classification, the Disjoint Graph Construction algorithm to transform the rule set into a disjoint graph, and the Disjoint Graph Search algorithm to find the best matching rule for the packet on the disjoint graph.

The Disjoint Graph data structure for a given rule set with D fields in each rule has D layers. Each node in the disjoint graph has an associated rule set. The first layer of the disjoint graph is an elementary interval tree (EIT) constructed for the set of integer intervals belonging to the first field of rules in the rule set. Besides the first layer, the j-th layer of the disjoint graph consists of a set of disjoint interval trees (Fⱼ-DITs) and a set of elementary interval trees (Fⱼ-EITs). The set of Fⱼ-DITs are constructed for the integer intervals stored in each node of the Fⱼ₋₁-EITs in the (j−1)-th layer. The set of Fⱼ-EITs are constructed for the integer intervals stored in each node of the Fⱼ-DITs in the j-th layer.

The disjoint graph is constructed based on two structures: Elementary Interval Tree (EIT) and Disjoint Interval Tree (DIT). Given a set of integer intervals, its elementary intervals and disjoint intervals can be represented by trees, which are called the elementary interval tree and disjoint interval tree. Each node in EIT (DIT) stores one of the elementary (disjoint) intervals of the set of integer intervals. The components of the disjoint graph, Fⱼ-EIT and Fⱼ-DIT enhance the EIT and DIT by setting an associated rule set (ARS) to each node of EIT and DIT. The associated rule set of a node in Fⱼ-EIT contains rules whose j-th field contains the elementary interval stored in the node, while the associated rule set of a node in Fⱼ-DIT contains rules whose j-th field is contained by the disjoint interval stored in the node.

The EIT component alone would be enough to construct a data structure that satisfies the requirement of a single path to be traversed to find the best matching rule for a packet by constructing EITs for the associated rule set of the nodes of the constructed EIT until no more EIT can be constructed. However, duplicated sub-EITs will be constructed in such data structure when the associated rule sets of the nodes in one EIT are overlapping with each other. These duplicated sub-EITs are redundant and should be shared to save storage space for the data structure. Unfortunately, duplicated sub-EITs may not be shared by two EITs if the sub-EIT is in the “middle” of an EIT. Thus, DITs are constructed to enable the sharing of the duplicated sub-EITs.

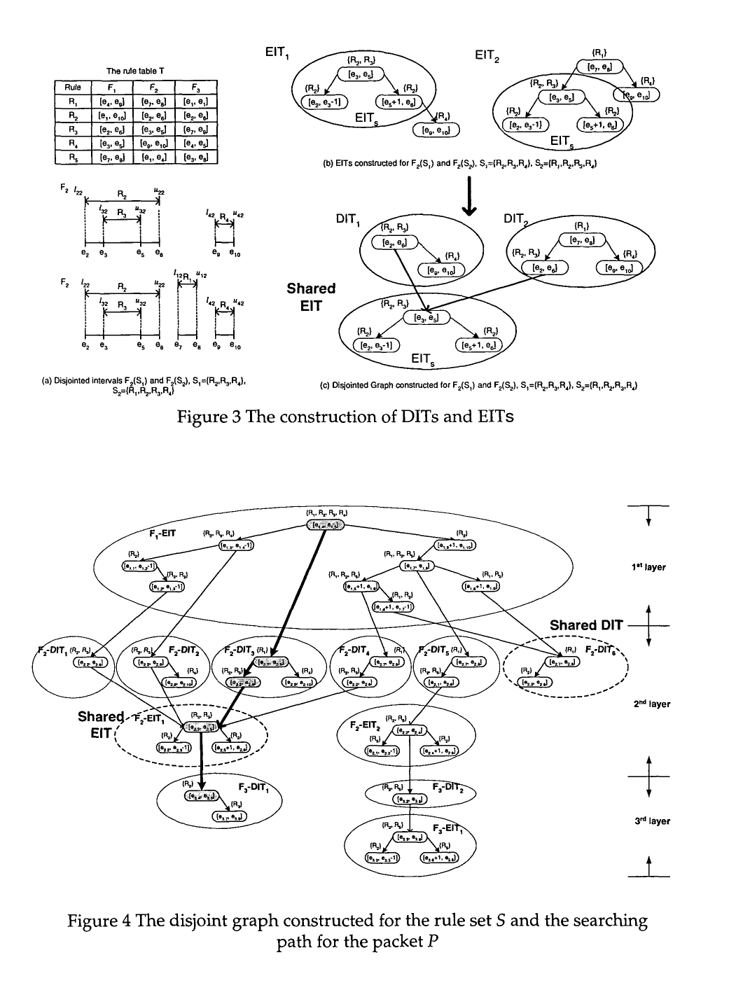

For example, FIG. 3 is the example of DIT and EIT construction. FIG. 3.c shows that two EITs have a duplicated sub-EIT, but they can't share the duplicated sub-EITs since the sub-EIT is in the “middle” of both EITs. But when we create a DIT for each EIT, we can use the DITs to replace the original EITs and let the two DITs share a single sub-EIT.

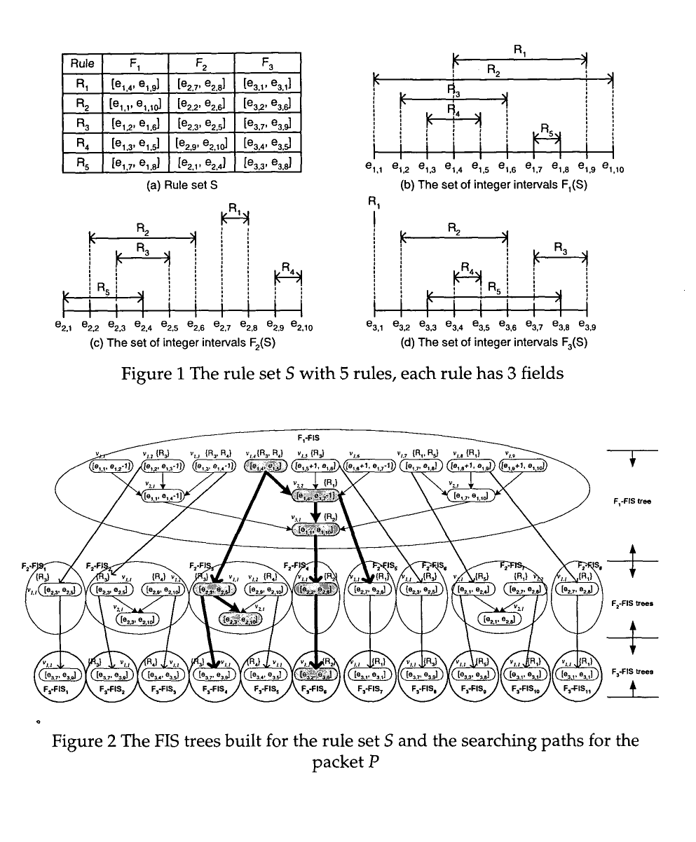

FIG. 4 is the Disjoint Graph G constructed for the set of rules S with 3 fields given in FIG. 1. G has 3 layers: 1) layer 1 contains one F₁-EIT constructed for the rule set S; 2) layer 2 contains six F₂-DITs for associated rule sets of nodes in the F₁-EIT and two F₂-EITs constructed for associated rule sets (ARSs) of nodes in the six F₂-DITs, because there are six different ARSs whose sizes are greater than 1 in the F₁-EIT and two different ARSs whose sizes are greater than 1 in the six F₂-DITs; 3) layer 3 contains two F₃-DITs constructed for ARSs of nodes in the two F₂-EITs and one F₃-EIT constructed for ARSs of nodes in the two F₃-DITs, because there are two different ARSs whose sizes are greater than 1 in the two F₂-EIT and two different ARSs whose sizes are greater than 1 in the two F₃-DITs.

The Disjoint Graph Construction algorithm takes a rule set S with N rules and D fields as input, and returns a disjoint graph G as output.
Input: rule set S={R₁, . . . , R_{N}}, where Rᵢ={Fᵢ₁,Fᵢ₂, . . . , F_{iD}}, i∈[1,N].
Output: disjoint graph G.
   Disjoint Graph Construction Algorithm (S)

Step 1. Construct the First Layer of the Disjoint Graph G

Construct an F₁-EIT for integer interval F₁(S) using the EITC algorithm

Step 2. Construct the k-th Layer of the Disjoint Graph G, k∈[2, D]

1. Construct a Fₖ-DIT in the k-th layer for each node of Fₖ₋₁-EIT in the (k−1)-th layer and connect the node to the root of the newly constructed Fₖ-DIT
a. Given a node v with an associated rule set Sᵥ of an Fₖ₋₁-EIT in the (k−1)-th layer, construct a Fₖ-DITᵥ, for the set of integer intervals Fₖ(Sᵥ) using the DITC algorithm, connect v to the root of Fₖ-DITᵥ. If Sᵥ has only one rule, directy associate the rule to v;
b. If the associated rule set S_{v′} of another node v′ is the same as Sᵥ, then Fₖ-DITᵥ is shared by v and v′, and node v′ is also connected to the root of Fₖ-DITᵥ;
c. Repeat a to c to construct Fₖ-DITs for all the nodes in the Fₖ₋₁-EITs.

2. Construct a Fₖ-EIT in the k-th layer for each node in the Fₖ-DITs in the k-th layer and connect the node to the root of the newly constructed Fₖ-EIT
a. Given a node v with an associated rule set Sᵥ of an Fₖ-DIT in the k-th layer, construct an Fₖ-EITᵥ, for the set of integer intervals Fₖ(Sᵥ) using the EITC algorithm, connect v to the root of Fₖ-EITᵥ. If Sᵥ has only one rule, directy associate the rule to v;
b. If the associated rule set S_{v′} of another node v′ is the same as Sᵥ, then Fₖ-EITᵥ, is shared by v and v′, and node v′ is also connected to the root of Fₖ-EITᵥ;
c. Repeat a to c to construct Fₖ-EITs for all the nodes in the Fₖ-DITs.

Repeat Step 2 until the D-th Layer of the Disjoint Graph G is Constructed.

The Disjoint Graph Search algorithm takes a disjoint graph G constructed by disjoint graph construction algorithm and a packet P as inputs, and returns the best matching rule of P as output.

Disjoint Graph Search Algorithm (G, P)

The search starts from the root of the F₁-EIT tree in the first layer of the G.

Step 1. Search the Fₖ-EITs in the k-th layer of G, k∈[1,D]
The search performed on the node v of the Fₖ-EIT with the associated rule set Sᵥ and integer interval Ĩᵥ=[\tilde{l}ᵥ,ũᵥ] can be divided in three cases:
Case 1: fₖ<\tilde{l}ᵥ
Perform search on the left child of v if the left child exists. If the left child does not exist, there is no matching rule for P in G.
   fₖ>ũᵥ Case 2:
Perform search on the right child of v if the right child exists. If the right child does not exist, there is no matching rule for P in G.
   \tilde{l}ᵥ≦fₖ≦ũᵥ Case 3:
Perform search on Fₖ₊₁-DITᵥ in the (k+1)-th layer if the Fₖ₊₁-DITᵥ exists. If Fₖ₊₁-DITᵥ does not exists, the best matching rule of P is the rule has the smallest rule number in Sᵥ.

Step 2. Search the Fₖ₊₁-DITᵥ in the (k+1)-th layer of G, k∈[1, D−1]

The search performed on the node v of the Fₖ₊₁-DITᵥ, with the associated rule set Sᵥ and integer interval Îᵥ=[Îᵥ,ûᵥ] can be divided in three cases:
Case 1: fₖ₊₁<\hat{l}ᵥ
Perform search on the left child of v if the left child exists. If the left child does not exist, there is no matching rule for P in G.
Case 2: fₖ₊₁>ûᵥ
Perform search on the right child of v if the right child exists. If the right child does not exist, there is no matching rule for P in G.
Case 3: \hat{l}ᵥ≦fₖ₊₁≦ûᵥ
Perform search on Fₖ₊₁-EITᵥ in the (k+1)-th layer if the Fₖ₊₁-EITᵥ, exists. If Fₖ₊₁-EITᵥ does not exists, the best matching rule of P is the rule has the smallest rule number in Sᵥ.

The Disjoint Graph based classification algorithm requires only a single path to be traversed when perform the classification for a packet, thus reduces the searching time required by the FIS trees based classification algorithm. In addition, since identical EITs (DITs) are constructed only once, the building time and the storage space are saved.

Also, in accordance with the invention, given a set of intervals and a point, the Elementary Interval Tree is presented to represent the set of intervals to support stabbing query, the Elementary Interval Tree Construction algorithm to construct the set of intervals to an elementary interval tree, and the Elementary Interval Tree Query algorithm to perform stabbing query on the elementary interval tree to find all intervals that contain a given point.

Given a set of intervals I={I₁,I₂, . . . Iₙ}={[l₁,u₁], [l₂,u₂], . . . , [lₙ,uₙ]}, the set of elementary intervals of I is defined as {Ĩ₁,Ĩ₂, . . . , Ĩ_{K}}:
1. Put all lower bounds and upper bounds of I into an array E, E={l₁,u₁, . . . , lₙ,uₙ};
2. Sort E in ascending order, delete duplicated elements, denote E as E={e₁, . . . , e_{K}}, e₁<e₂< . . . <e_{K}, 1≦k≦2n;
3. Ĩₖ⊂[eₖ,eₖ₊₁]⊂Iᵢ, 1≦k≦K−1 , iff (eₖ∉U or eₖ₊₁∉L), 1≦i≦n; (two successive elementary bounds eₖ and eₖ₊₁ define an elementary interval, unless the first bound eₖ is an upper bound and the second bound eₖ₊₁ is a lower bound)
4. I₁∪I₂∪ . . . ∪Iₙ=Ĩ₁∪Ĩ₂∪ . . . ∪Ĩ_{K-1};
5. ∀Ĩₐ, Ĩ_{b}, a≠b, Ĩₐ∩Ĩ_{b}=Ø.

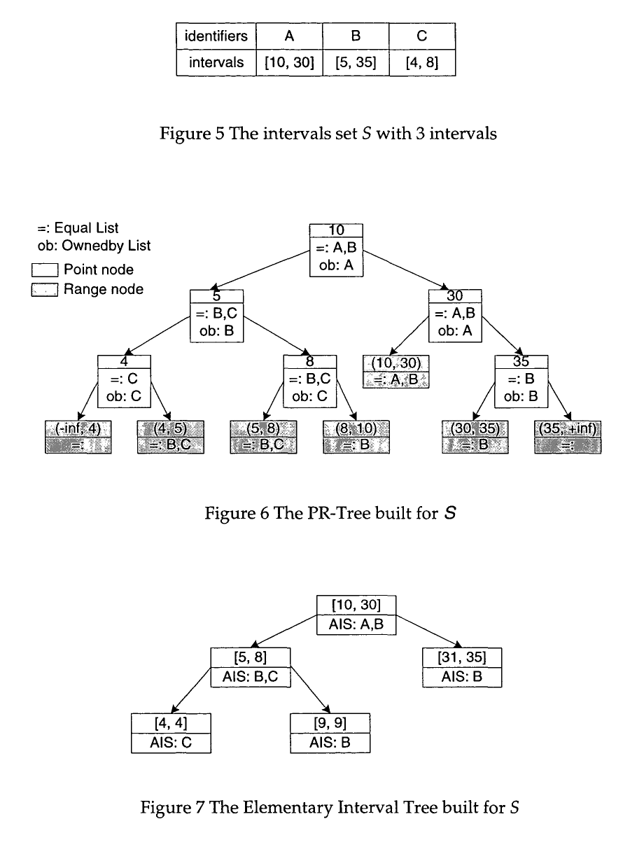

For example, given a set of intervals (FIG. 5) {[10, 30], [5, 35], [4, 8]}, the elementary intervals are {[4, 4], [5, 8], [9, 9], [10, 30], [31, 35]}.

The Elementary Interval Tree is an augmented binary search tree that stores each of the elementary intervals in one node to represent a set of intervals. Each node in the elementary interval tree has LB, UB, Left, Right, and AIS fields, where LB and UB are lower and upper endpoint of an elementary interval, respectively, Left and Right are pointers to left and right subtree, respectively, and AIS (Associated Interval Set) is a list of identifiers of intervals that contain the elementary interval stored in the node.

The Elementary Interval Tree Construction (EITC) algorithm takes a set of intervals I={I₁,I₂, . . . , Iₙ} as input, and returns an elementary tree EIT as output.

Elementary Interval Tree Construction Algorithm (I)

Step 1: Create the root node V for EIT
1. Store the integer interval I_{V}=[l_{V},u_{V}]=[l₁,u₁] in V;
2. Store the list of identifiers of intervals AIS_{V}={I₁} in V;
3. Remove I₁ from I, I=I−I₁.

Step 2: Insert Iᵢ=[lᵢ,uᵢ], i∈[2,n], to the EIT
1. Compare Iᵢ to I_{V}
   Case 1: uᵢ<l_{V}
If the left child node of V does not exist, v_{L}=Ø, create v_{L}, store Iᵢ in v_{L} and add Iᵢ to AIS of v_{L}.
If v_{L}≠Ø, recursively insert Iᵢ to the left sub-EIT with the root v_{L}.
   Case 2: lᵢ>u_{V}
If the right child node of V dose not exist, v_{R}=Ø, create v_{R,} store Iᵢ in v_{R} and add Iᵢ to AIS of v_{R}.
If v_{R}≠Ø, recursively insert Iᵢ to the right sub-EIT with the root v_{R}.
   Case 3: Iᵢ∩I_{V}≠Ø
      I_{L}=[min(lᵢ,l_{V}),max(lᵢ,l_{V})−1]
      I_{R}=[min(uᵢ,u_{V})+1,max(uᵢ,u_{V})]
      I_{V}=[lᵥ,u_{V}]=[max(lᵢ,l_{V}),min(uᵢ,u_{V})]
Insert integer intervals I_{L} and I_{R} to EIT
   If I_{L}≠Ø
      If v_{L}=Ø, create v_{L}, store I_{L} in v_{L};
      If v_{L}≠Ø, recursively insert I_{L} to the left sub-EIT with the root v_{L}.
   If I_{R}≠Ø
      If v_{R}=Ø, create v_{R}, store I_{R} in v_{R};
      If v_{R}≠Ø, recursively insert I_{R} to the right sub-EIT with the root v_{R}.
2. Remove Iᵢ from I, I=I−Iᵢ

Repeating Step 2 Until I=Ø

The Elementary Interval Tree Query (EITQ) algorithm takes the elementary interval tree EIT constructed for a set of intervals by EITC algorithm and a point P as inputs, and returns a list of identifiers of intervals that contains P as output.

Elementary Interval Tree Query Algorithm (EIT, P)

Start from the root node V of EIT
Case 1. If l_{V}≦P≦u_{V}, return AIS_{V};
Case 2. If P<l_{V}, recursively search the left sub-EIT rooted at the left child node of V, v_{L};
Case 3. If P>u_{V}, recursively search the right sub-EIT rooted at the right child node of V, v_{R};
Case 4. If the EIT is empty, return NULL.

The Elementary Interval Tree contains only the Range nodes in the PR-Tree, thus it consumes only half of the memory storage required by the PR-Tree. The Elementary Interval Tree allows dynamic insertion (Step 2 of EITC algorithm) and deletion, while maintaining the tree balanced as well as the PR-Tree. Any balanced binary tree scheme could be used to perform the tree balancing operation on elementary interval tree. The balanced Elementary Interval Tree keeps the searching time as ο(log n) and reduces the worst case insertion time to ο(n log n), where n is the total number of intervals.

The advantages of the Elementary Interval Tree are: 1) reduction of the memory storage required by the PR-Tree to half, 2) reduction of the insertion and deletion time compared with the PR-Tree.

Given a set of intervals S shown in FIG. 5, FIG. 6 is the PR-Tree constructed for S, and FIG. 7 is the Elementary Interval Tree built for S.

The commercial value of the Elementary Interval Tree lies in the role as solution to stabbing queries, which is a necessary element in applications such as IP routers. Furthermore, the extension of Elementary Interval Tree to multiple dimensional domains provides a solution to packet classification in IP routers. Classification is a very important function that is a part of applications such as firewall, IPsec, Quality of service. Firewall needs to classify packets based on pre-defined set of rules so that it can filter/block some flow packets from entering the network. IPsec needs to classify packets based on rules so that specific flow packets can be matched to the corresponding security policy and associations that indicate the security algorithms, secure keys to be applied to the flow packets. Quality of service needs to perform classification function on packets, so that Quality of service attributes like delay bounds, packet loss bounds, bandwidth can be associated with the flow packets. In VPN environments, all the three applications of firewall, IPsec, and Quality of service may have to be applied to the edge router device. Hence, efficient implementation of the classification function becomes even more vital in such environments.

Given a set of intervals, the Disjoint Interval Tree represents a set of intervals to facilitate queries such as stabbing query and intersection query, the Disjoint Interval Tree Construction algorithm transforms a set of intervals to a disjoint interval tree and thus to find the disjoint intervals for the set of intervals, the Disjoint Interval Tree Point Query algorithm performs stabbing query on the disjoint interval tree, and the Disjoint Interval Tree Interval Query algorithm performs intersection query on the disjoint interval tree.

Given a set of intervals, I={I₁,I₂, . . . Iₙ}, the set of disjoint intervals of I is defined as {Î₁,Î₂, . . . ,Î_{L}},
1. I₁∪I₂∪ . . . ∪Iₙ=Î₁∪Î₂∪ . . . ∪Î_{L};
2. ∀Îₐ,Î_{b}, a≠b, Îₐ∩Î_{b}=Ø;
3. ∀Îₗ, Îₗ=I₁∪ . . . ∪I_{K}′, Iₖ′∈{I₁,I₂, . . . , Iₙ}, 1≦k≦K;
4. ∀Iᵢ, ∃Îₐ, lᵢ⊂Î_{b}, ∀Î_{b},Î_{b}≠Îₐ,IᵢÎ_{b}.

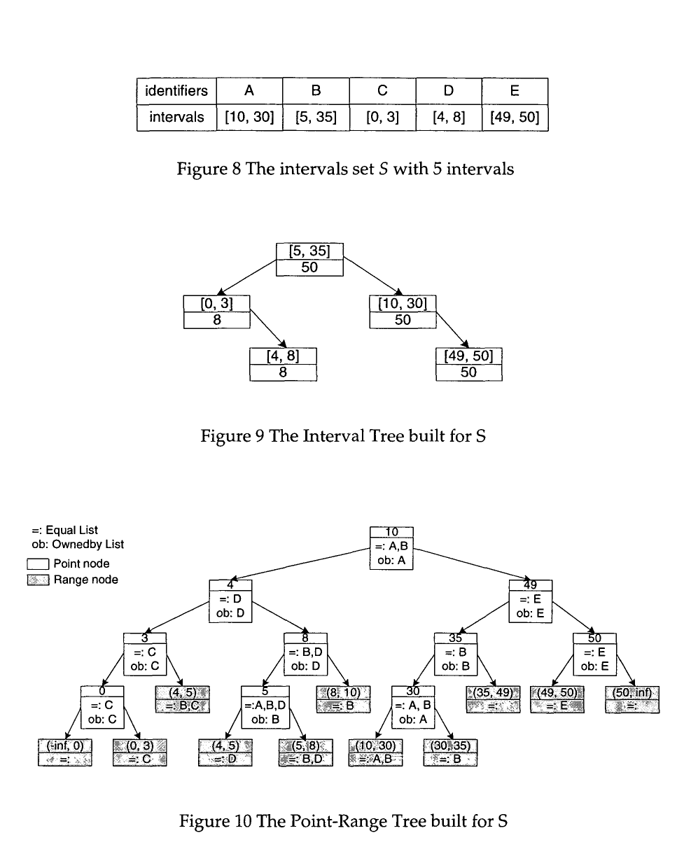

The disjoint intervals combine the overlapping intervals in the set of intervals together to form larger intervals that are disjoint to each other. For example, given a set of intervals {[10, 30], [5, 35], [0, 3], [4, 8], [49, 50]} (FIG. 8), the disjoint intervals are {[0, 3], [4, 35], [49, 50]}.

The Disjoint Interval Tree is a binary search tree that stores each of the disjoint intervals in one node to represent a set of intervals. Each node in the disjoint interval tree has LB, UB, Left, Right, and AIS fields, where LB and UB are lower and upper endpoints of a disjoint interval, respectively, Left and Right are pointers to left and right subtree, respectively, and AIS (Associated Interval Set) is a list of identifiers of intervals that is contained by the disjoint interval stored in the node.

The Disjoint Interval Tree Construction (DITC) algorithm takes a set of intervals I={I₁,I₂, . . . , Iₙ} as input and returns a disjoint interval tree DIT as output.

Disjoint Interval Tree Construction Algorithm (I)

Step 1: Create the root node V for DIT
1. Store the integer interval I₁=[l₁,u₁] in V, I_{V}=[l_{V},u_{V}]=[l₁,u₁]
2. Store the list of identifiers of intervals AIS_{V}={I₁} in V;
3. Remove I₁ from I, I=I−I₁

Step 2: Insert I=[lᵢ,uᵢ], i∈[2,n], to the DIT
1. Compare Iᵢ and I_{V}
   Case 1: uᵢ<l_{V}.
If the left child node of V does not exist, v_{L}=Ø, create v_{L}, store Iᵢ in v_{L} and add Iᵢ to AIS of v_{L}.
If v_{L}≠Ø, recursively insert Iᵢ to the left sub-DIT with the root v_{L}.
   Case 2: lᵢ>u_{V}.
If the right child node of V does not exist, v_{R}=Ø, create v_{R}, store Iᵢ in v_{R} and add Iᵢ to AIS of v_{R}.
If v_{R}≠Ø, recursively insert Iᵢ to the right sub-DIT with the root v_{R}.
   case 3: Iᵢ∩I_{V}≠Ø.
If lᵢ<l_{V} and there exist children lcv on the left of v that verify the condition u_{lcv}≧lᵢ and leftmostcv is one of these children that is most to the left; then 1) discard these children; 2) set lᵥ=l_{leftmostlcv}; 3) connect I_{V} to the leftover DIT sub-tree on the left
If lᵢ<l_{V} and there are no children lcv on the left of v that verify the condition u_{lcv}≧lᵢ, then set lᵥ=li
If uᵢ>l_{V} and there exist children rcv on the right of v that verify the condition l_{rcv}≦uᵢ, and rightmostcv is one of these children that is most to the right; then 1) discard these children; 2) set uᵥ=u_{rightmostcv}; 3) connect I_{V} to the leftover DIT sub-tree on the right.
If uᵢ>u_{V} and there are no children rcv on the right of v that verify the condition l_{rcv}≦uᵢ, then set uᵥ=uᵢ
   I_{V}=[l_{V},u_{V}]
2. Remove Iᵢ from I, I=I−Iᵢ

Repeat Step 2 until I=Ø

The Disjoint Interval Tree Point Query (DITPQ) algorithm takes the disjoint interval tree DIT constructed for a set of intervals by DITC algorithm and a point P as inputs, and returns a list of identifiers of intervals that might contain P as output.

Disjoint Interval Tree Point Query Algorithm (DIT, P)

Start from the root node V of DIT
Case 1. If l_{V}≦P≦u_{V}, return AIS_{V};
Case 2. If P<l_{V}, recursively search the left sub-DIT rooted at the left child node of V, v_{L};
Case 3. If P>u_{V}, recursively search the right sub-DIT rooted at the right child node of V, v_{R};
Case 4. If the DIT is empty, return NULL.

The Disjoint Interval Tree Interval Query (DLTIQ) algorithm takes the disjoint interval tree DIT constructed for a set of intervals by DITC algorithm and an interval [l, u] as inputs, and returns a list of identifiers of intervals that might overlap [l, u] as output.

Disjoint Interval Tree Interval Query Algorithm (DIT, l, u)

Start from the root node V of DIT
Case 1. If [l,u]∩[l_{V},u_{V}]≠Ø, return AIS_{V};
Case 2. If u<l_{V}, recursively search the left sub-DIT rooted at the left child node of V, v_{L};
Case 3. If I>u_{V}, recursively search the right sub-DIT rooted at the right child node of V, v_{R};
Case 4. If the DIT is empty, return NULL.

The Disjoint Interval Tree allows dynamic insertion while the closest prior art solution proposed in U.S. Pat. No. 6,539,394 does not support dynamic insertion as shown in next paragraph. And the disjoint interval tree is able to maintain balance by any balanced binary tree scheme.

The disjoint interval tree can be used with other data structures such as Elementary Interval Tree to form a data structure to support intersection query, stabbing query, packet classification, etc. For example, after constructing the disjoint interval tree, it is possible to construct an elementary interval tree for each associated rule set in the disjoint interval tree. The data structure formed by balanced disjoint interval tree and balanced elementary interval trees takes ο(log n) time for intersection query or stabbing query. To find all intervals that overlap a given interval, DITIQ algorithm could be used to find the set of intervals that are possible to overlap the given interval and then the set of intervals that overlap the given interval can be quickly found in the small size interval set. Similarly, to find all intervals that contain a given point, DITPQ algorithm could be used to find the set of intervals that are possible to contain the given point.

Here the differences of the DIT as compared with the method proposed in U.S. Pat. No. 6,539,394 are apparent. The method is a static algorithm that needs to reconstruct the decision tree when inserts or deletes an interval from the interval set.

Given a set of intervals I={I₁,I₂, . . . , Iₙ}={[l₁,u₁],[l₂,u₂], . . . ,[lₙ,uₙ]}, the method performs the following operations:
1) Puts all lower endpoints {l₁,l₂, . . . ,lₙ} to an array, sorts them in ascending order and deletes duplicated elements to result a set of endpoints {le₁,le₂, . . . , leᵢ}, i<n, and uses the set of endpoints to form a set of intervals LE={[0,le₁),[le₁,le₂),[le₂,le₃), . . . [leᵢ,max)}where |LE |=i+1 and max is the maximum possible. For example, given a set of intervals {[1,3],[4,5],[2,8]}, we get the interval set LE={[0,1),[1,2),[2,4),[4,max)};
2) Performs the same operation on the upper endpoints {u₁,u₂, . . . , uₙ} to get a set of intervals UE={(0,0],(0,ue₁], ue₁,ue₂], . . . , (ueⱼ,max]}, where j≦n, and |UE|=j+2;
3) For the interval set LE, uses w₁=┌log |LE |┐ bits to label each interval of the interval set starting from all 0's for the first interval. For example, intervals in {[0,1),[1,2),[2,4),[4,max)} will be labeled as 00 for [0,1), 01 for [1,2), 10 for [2,4), and 11 for [4,max);
4) Labels each interval in the interval set UE using w₂=┌log |UE |┐ bits;
5) Builds a n×(w₁+w₂) matrix M for the set of intervals I, one row for each interval and (w₁+w₂) elements for each row: 1) gets the bit labels of all intervals in LE that are contained by the interval, keeps the common bits of these intervals and set other bits to wildcard*to get a w₁ bits prefix, and 2) gets a w₂ bits prefix for the interval similarly based on the interval set UE. For example, the interval [2, 8] contains intervals [2,4),[4,max) in LE that are labeled as 10 and 11 respectively, which results 1*;
6) Constructs a decision tree based on the matrix M:
   a) Choose the column having a minimal number of wildcards and if more than one such column, choose the lowest index column having the closest equal number of ‘1’s and ‘0’s, and this column will be the first node of the decision tree;
   b) Derives two matrices from M by eliminating the rows having ‘0’s and ‘1’s, respectively, in the selected column, and by eliminating the selected column from the new matrices;
   c) Recursively selects columns from the matrices and creates nodes until the decision tree is built, that the given intervals are distinguished from each other.

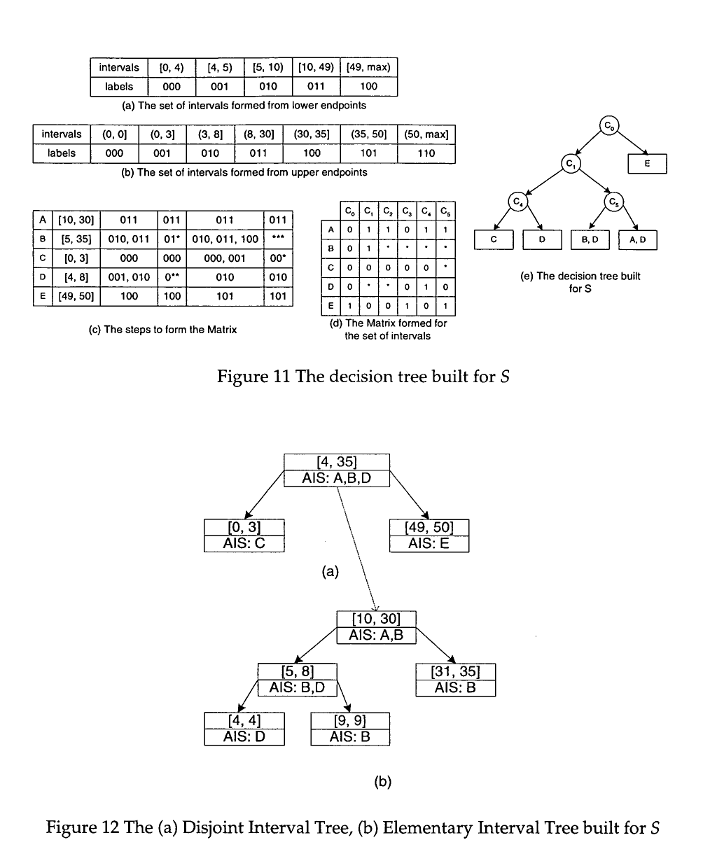

An example of the decision tree built for the set of intervals in FIG. 8 is given in FIG. 11.

Although particular embodiments of the invention have been described and illustrated it will be apparent to one skilled in the art that numerous changes can be made without departing from the basic concepts. For example, the treelike data structures for creating the disjoint graph, as well as the EIT and DIT can be stored on a computer readable medium for packet classification. It is to be understood, however, that such changes will fall within the full scope of the invention as defined by the appended claims.

1. A method of creating a tree-like data structure for use in carrying out range specified rule evaluations, the data structure having a rule specified rule set where each rule in the rule set has an equal number of fields and each field specifies a range having an upper and lower bound, there being the same number of layers in the structure as there are fields in each rule set, the method comprising:
creating a first layer of the structure made up of a set of non-overlapping ranges; and
creating one or more additional layers each made up of sets of non-overlapping ranges and sets of overlapping ranges;
wherein range specified rule evaluations are carried out by one pass through the data structure.

2. The method as defined in claim 1 wherein the data structure is a disjoint graph with the non-overlapping ranges representing elementary intervals and the overlapping ranges are disjoint intervals.

3. The method as defined in claim 2 wherein the range specified rule evaluations relate to packet classification in communications systems.

4. A system for creating a tree-like data structure for use in carrying out range specified rule evaluations, the data structure having a rule specified rule set where each rule in the rule set has an equal number of fields and each field specifies a range having an upper and lower bound, there being the same number of layers in the structure as there are fields in each rule set, the system comprising:
means for creating a first layer of the structure made up of a set of non-overlapping ranges; and
means for creating one or more additional layers each made up of sets of non-overlapping ranges and sets of overlapping ranges;
wherein range specified rule evaluations are carried out by one pass through the data structure.

5. The system as defined in claim 4 wherein the data structure is a disjoint graph with the non-overlapping ranges representing elementary intervals and the overlapping ranges are disjoint intervals.

6. A tree-like data structure stored on a computer readable medium for use in carrying out range specified rule evaluations, the data structure having a rule specified rule set where each rule in the rule set has an equal number of fields and each field specifies a range having an upper and lower bound, there being the same number of layers in the structure as there are fields in each rule set, the tree-like data structure having a first layer made up of a set of non-overlapping ranges; and one or more additional layers each made up of sets of non-overlapping ranges and sets of overlapping ranges; wherein range specified rule evaluations are carried out by one pass through the data structure.

7. The tree-like data structure as defined in claim 6 wherein the data structure is a disjoint graph with the non-overlapping ranges representing elementary intervals and the overlapping ranges are disjoint intervals for performing evaluations relating to packet classification in communications systems

8. A method of creating an augmented binary tree structure from a range specified rule set, each rule in the rule set having an equal number of fields and each field specifying a range having an upper and lower bound forming a set of intervals, the method comprising:
projecting end points of each interval of the set of intervals onto a line, the end points dividing the line into non-overlapping elementary intervals; and
forming the tree structure such that each node of the tree contains a single elementary interval, an indication of original intervals associated with the elementary interval, and pointers to any adjacent nodes in the tree.

9. The method as defined in claim 8 wherein the augmented binary tree structure is used for stabbing queries.

10. The method as defined in claim 8 wherein the augmented binary tree structure is an elementary interval tree for use in packet classification of computer-based communications systems.

11. A system for creating an augmented binary tree structure from a range specified rule set, each rule in the rule set having an equal number of fields and each field specifying a range having an upper and lower bound forming a set of intervals, the method comprising:
means for projecting end points of each interval of the set of intervals onto a line, the end points dividing the line into non-overlapping elementary intervals; and
means for forming the tree structure such that each node of the tree contains a single elementary interval, an indication of original intervals associated with the elementary interval, and pointers to any adjacent nodes in the tree.

12. The system as defined in claim 11 wherein the augmented binary tree structure is used for stabbing queries

13. The system as defined in claim 11 wherein the augmented binary tree structure is an elementary interval tree for use in packet classification of computer-based communications systems.

14. A method of creating a disjoint interval tree from a range specified rule set each rule in the rule set having an equal number of fields and each field specifying a range having an upper and lower bound forming a set of intervals, the method comprising:
combining overlapping intervals of the set of intervals to form larger intervals that are disjoint to each other; and
evaluating the overlapping intervals to find the maximum disjoint intervals for the set of intervals.

15. The method as defined in claim 11 for use in packet classification in a computer based communications system.

16. A system for creating a disjoint interval tree from a range specified rule set each rule in the rule set having an equal number of fields and each field specifying a range having an upper and lower bound forming a set of intervals, the method comprising:
means for combining overlapping intervals of the set of intervals to form larger intervals that are disjoint to each other; and
means for evaluating the overlapping intervals to find the maximum disjoint intervals for the set of intervals.

17. The system as defined in claim 16 for use in packet classification in a computer based communications system.

18. An augmented binary tree structure created in accordance with the method of claim 8 stored on a computer readable medium for classifying packets.

19. A disjoint interval tree created in accordance with the method of claim 14 stored on a computer readable medium for classifying packets.
